(19) United States
(12) Patent Application Publication
(10) Pub. No.: US 2011/0242013 A1
(43) Pub. Date: Oct. 6, 2011

(54) INPUT DEVICE, MOUSE, REMOTER, CONTROL CIRCUIT, ELECTRONIC SYSTEM AND OPERATION METHOD

(75) Inventor: CHUN-WEI HO, Taipei (TW)

(73) Assignee: I Zone Technologies Co., Ltd, Taipei City (TW)

(21) Appl. No.: 12/849,143

(22) Filed: Aug. 3, 2010

(30) Foreign Application Priority Data
Apr. 1, 2010 (TW) 099110209

(51) Int. Cl. G06F 3/041

(52) U.S. Cl. 345/173

(57) ABSTRACT

An input device comprises a base, an upper shell, a sensor array and a processing module. The upper shell covers the base, and has a plurality of operation areas. The sensor array has a plurality of sensors under the upper shell at array, and each of the sensors is configured for detecting a corresponding one of the operation areas. When any one of the operation areas is touched, a sensor corresponding to a touched operation area is enabled to output a detection signal with a first status to the processing module. At the moment, the processing module generates a corresponding operation instruction.

### BACKGROUND

1. Technical Field

The present relates to an input device, and more particularly to a touch input device.

2. Description of the Related Art

Current input device adapted into computer system, comprises keyboard, mouse, trackball, rocker, touch panel, touch screen, etc. The input device can make user perform many operations on display screen of the computer system, such as paging, scrolling, moving, zooming, etc.

When the user employs the conventional input device, such as mouse, to control the display screen of the computer system for reading file or web-page, there often meets some questions. If length of the file or web-page read by the user is larger than the maximum length displayed by the display screen of the computer system, it will display a longitudinal moving axis on the right side of the display screen. The user may operate the mouse to move the longitudinal moving axis, thus image displayed on the display screen can be scrolled up or down. However, the above operation is inconvenient for the user.

For making the user more easily and visualized operate, the conventional mouse generally disposes a wheel between two function keys. The user can employ a finger to roll the wheel of the conventional mouse, such that it is easy to scroll up or down the image. It is well-known that the user also can operate page keys or direct keys of keyboard, to scroll up or down the image.

On the contrary, if width of the file or web-page read by the user is larger than the maximum width displayed by the display screen, it will display a lateral moving axis. Similarly, the user may operate the mouse to move the lateral moving axis, thus the image can be scrolled to the left or the right. However, the above operation is inconvenient for the user.

### BRIEF SUMMARY

Accordingly, the present invention provides an input device and an electronic system, which can make user employ easy gesture with multi-fingers to perform relative function operations for reading file or web-page.

The present invention further provides to a control circuit and a control method, which can make the user conveniently control a host device.

An input device in accordance with a preferable exemplary embodiment of the present invention, comprises a base, an upper shell, a sensor array and a processing module. The upper shell covers the base and has a plurality of operation areas. The sensor array has a plurality of sensors which are disposed under the upper shell, and each of the sensors respectively detects a status of a corresponding one of the operation areas. When any one of the operation areas is touched, a sensor corresponding to a touched operation area is enabled. At the moment, the processing module generates a corresponding operation instruction according to a combination, a sequence and locations of enabled sensors when some of the sensors are enabled.

In some exemplary embodiment of the present invention, the input device further comprises a positioning module. The positioning module detects a location of a flat surface of the input device when the input device is used as a mouse, and generates a positioning signal to the processing module for generating the operation instruction.

In addition, the operation areas thereof are arranged at array or non-array.

From another viewpoint, a control circuit provided by the present invention is suitable for controlling a host device. The control circuit of the present invention comprises a sensor array and a processing module. The sensor array has a plurality of sensors arranged at array, and each of the sensors detects a status of one of a plurality of operation areas respectively. When any one of the operation areas is touched, a sensor corresponding to touched operation area is enabled. At the moment, the processing module generates a corresponding operation instruction according to a combination, a sequence and locations of enable sensors when some of the sensors are enabled.

From further another viewpoint, an electronic system provided by present invention, comprises a host device and an input device. The input device is linked with the host device for controlling the host device. The input device comprises an upper shell, a sensor array, a processing module and a positioning module. The sensor array has a plurality of sensors arranged under the upper shell at array, and each of the sensors is configured for detecting a status of one of the operation areas disposed on the upper shell. When any one of the operation areas is touched, a sensor corresponding to touched operation area is enabled. At the moment, a processing module generates a corresponding operation instruction according to a combination, a sequence and locations of enabled sensors when some of the sensors are enabled.

In a preferable exemplary embodiment of the present invention, each of the sensors has a corresponding pattern respectively, and the pattern of each of the sensors is made of a transparent material. In addition, a light-source module is disposed under the sensor array, which has a plurality of light-emitting diodes, and each of the light-emitting diodes corresponds to one of the sensors respectively. When the light-emitting diodes emit light, the pattern of each of the sensors is projected to corresponding operation areas respectively.

From further another viewpoint, a control method provided by the present invention comprises: disposing a plurality of sensors at array, to detect statuses of a plurality of operation areas respectively; and generating an operation instruction according to a combination, a sequence and locations of touched operation areas when some of the operation areas are touched. In addition, the operation instruction is transmitted to the host device for controlling the host device.

The present invention employs the plurality of sensors to sense the status of the plurality of operation areas. When any one of the operation areas is touched, the detection signal with the first status is transmitted to the processing module. Therefore, the present invention can make the user conveniently control the host device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block schematic view of an electronic system in accordance with a preferable exemplary embodiment of the present invention.

FIG. 2 is an exploded schematic view of an input device in accordance with a preferable exemplary embodiment of the present invention.

FIG. 3 is a circuit block view of a control circuit of a touch mouse in accordance with a preferable exemplary embodiment of the present invention.

FIG. 4A to 4C are schematic views of controlling the touch mouse in accordance with some exemplary embodiments of the present invention.

FIG. 5 is an exploded schematic view of an input device in accordance with another preferable exemplary embodiment of the present invention.

FIG. 6 is a circuit block view of a control circuit of the input device of FIG. 5 in accordance with a preferable exemplary embodiment of the present invention.

FIG. 7 is a circuit block view of a control circuit of a touch mouse with remote control function in accordance with a preferable exemplary embodiment of the present invention.

FIG. 8 is a flow chart of a control method for a host device in accordance with a preferable exemplary embodiment of the present invention.

FIG. 9 is a flow chart of a control method for a host device in accordance with another preferable exemplary embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

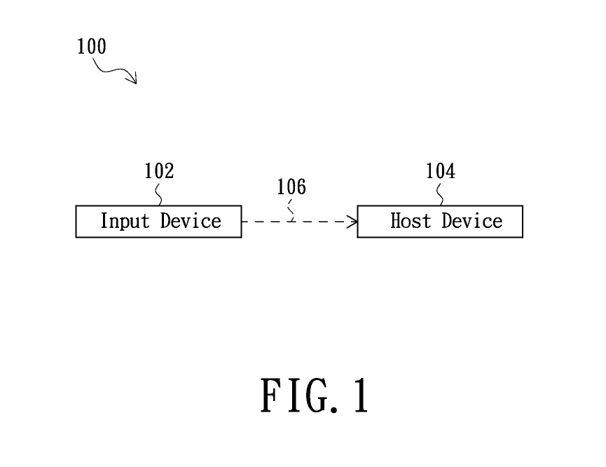

Refer to FIG. 1, which is a block schematic view of an electronic system in accordance with a preferable exemplary embodiment of the present invention. The electronic system 100 of the exemplary embodiment comprises an input device 102 and a host device 104. The input device 102 is linked with the host device 104 through a transmission interface 106. Thus, user can operate the input device 102 to control the host device 104.

In the exemplary embodiment, the transmission interface 106 may be a wire transmission interface, such as a universal serial bus (USB) transmission interface, or be a wireless transmission interface, such as an infrared transmission interface or a blue-tooth transmission interface. Furthermore, in some exemplary embodiments, the input device 102 may be mouse, presenter, remote controller, etc., which are described in detail in following. The host device 104 controlled by the input device 102, may be desktop computer, portable computer, projector, or general home electronic device, etc.

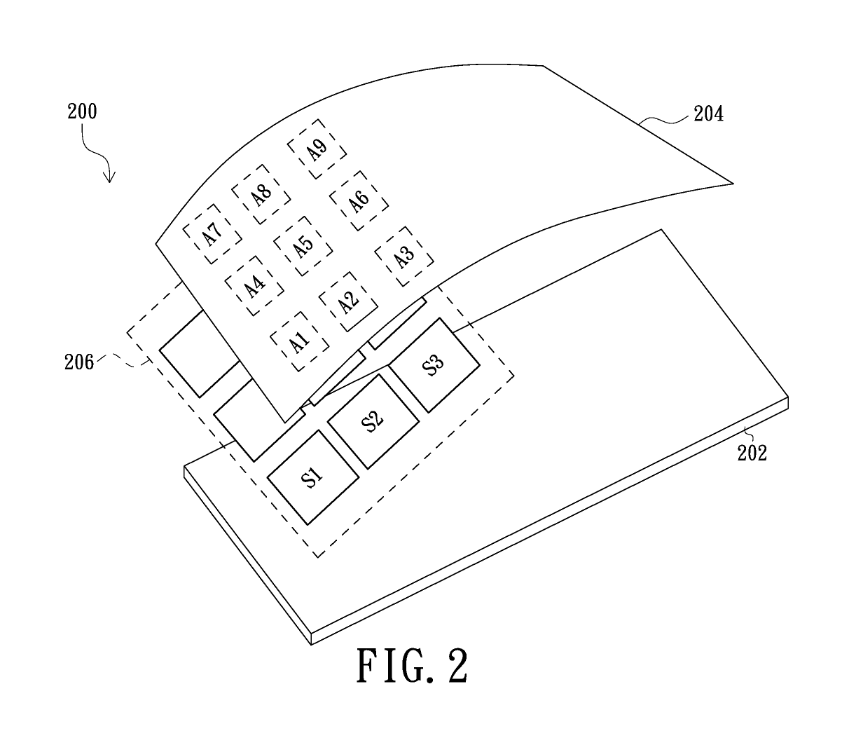

FIG. 2 is an exploded schematic view of an input device in accordance with a preferable exemplary embodiment of the present invention. Referring to FIG. 2, the input device 200 of the exemplary embodiment may be adapted into the input device 102 of FIG. 1, and comprises a base 202 and an upper shell 204. The upper shell 204 may be a general plastic shell and not be a special shell, such as touch panel. The upper shell 204 covers the base 202. Furthermore, the upper shell 204 may have a plurality of operation areas, such as A1˜A9 disposed thereon. In the exemplary embodiment, the operation areas A1˜A9 may be arranged at array. However, the present invention is not limited in this. In some alternative exemplary embodiment, the persons skilled in the art can arrange the operation areas at non-array, such as a round array or an ellipse array, etc. Those are all within the scope and spirit of the present invention.

More particularly, a sensor array 206 may be disposed under the upper shell 202. The sensor array 206 comprises a plurality of sensors, such as S1, S2, S3, which are arranged at array. Furthermore, each of the sensors detects a status of one of the operation areas A1˜A9 of the upper shell 202. In the exemplary embodiment, the sensors of the sensor array 206 may be capacitive sensors, resistive sensors, microwave sensors, or pressure sensors, etc.

The input device 200 of the exemplary embodiment can be used as a touch mouse.

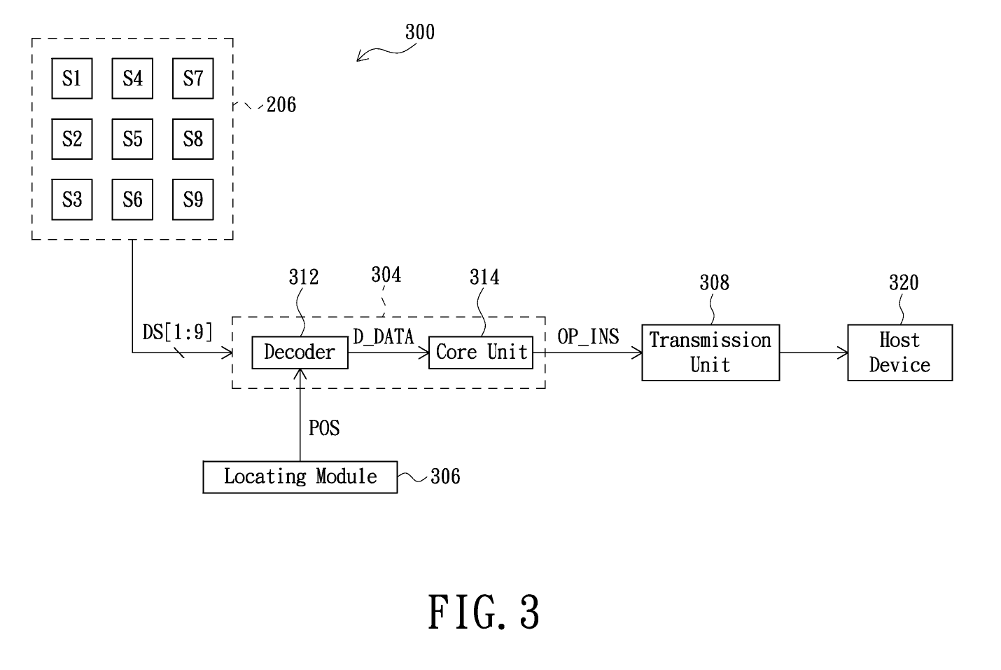

FIG. 3 is a circuit block view of a control circuit of the touch mouse in accordance with a preferable exemplary embodiment of the present invention. Refer to FIG. 3, the control circuit 300 of the touch mouse of the exemplary embodiment comprises a sensor array 206, a processing module 304 and a positioning module 306. The processing module 304 is coupled to the sensor array 206 and the positioning module 306. In some exemplary embodiments, the control circuit 300 further comprises a transmission unit 308 coupled to the processing module 304, and linked with the host device 320 through the wire transmission interface or the wireless transmission interface.

In the sensor array 206, each of the sensors S1˜S9 detects the status of one of the operation areas A1˜A9 respectively. If all of the operation areas A1˜A9 are not touched, the sensor array 206 outputs a detection signal DS[1:9] with a first status to the processing module 304. On the contrary, if any of the operation areas A1˜A9 is touched, the sensor corresponding to the touched operation area will output a detection signal DS[n] with a second status to the processing module 304. n is an integral number which is larger or equal to 1 and smaller or equal to 9. For example, when the operation area A1 is touched, the corresponding sensor S1 can output the detection signal DS[1] with the second status to the processing module 304.

The processing module 304 comprises a decoder 312 and a core unit 314. The core unit 314 is coupled to the decoder 312 and the transmission unit 308, and the decoder 312 is coupled to the sensor array 206 and the positioning module 306. When the sensor array 206 outputs the detection signal DS[n] with the second status to the processing module 304, the decoder 312 decodes the detection signal DS[n]. In addition, the decoder 312 further receives a positioning signal POS outputted from the positioning module 306, and decodes the positioning signal POS. In some exemplary embodiments, the positioning module 306 may be a trackball positioning module or an optical positioning module. In other exemplary embodiments, the positioning module also may be a gyroscope or performed by other locating technology. The present invention is not limited in these.

When the decoder 312 receives at least one of the detection signal DS[n] with the second status and the positioning signal POS, the decoder 312 decodes them and generates a decoding data D_DATA to the core unit 314. meanwhile, the core unit 314 generates an operation instruction OP_INS to the transmission unit 308 according to the decoding data D_DATA. Therefore, the operation instruction OP_INS is sent to the host device 320 through the transmission interface form the transmission unit 308 for controlling the host device 320. In the exemplary embodiment, the host device 320 may be a computer system, and comprises a display to display images.

The following provides a plurality of exemplary embodiments to describe how the user employ the touch mouse performed by the input device 200 of FIG. 2 to control the host device. In addition, it is obvious for the persons skilled in the art that the exemplary embodiments described in following are used to understand the spirit of the present invention, but they are not used to limit the present invention. Any one can devise variations in actual needs that are within the scope and spirit of the invention disclosed herein.

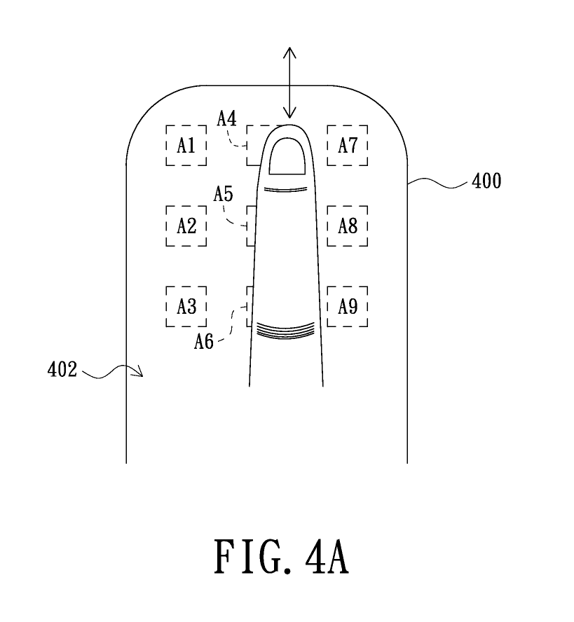

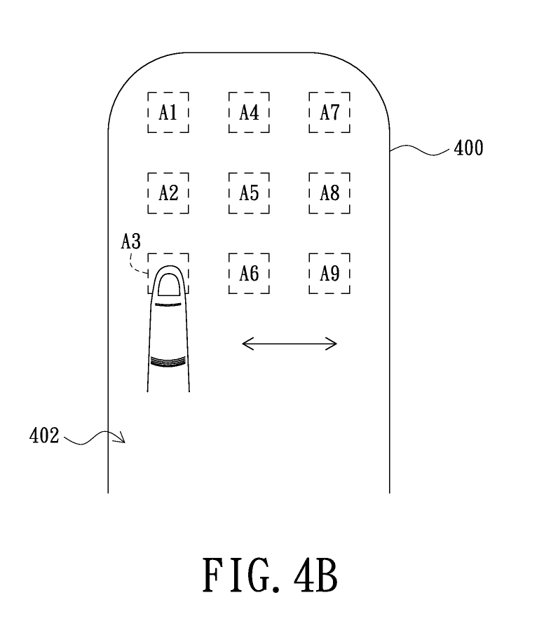

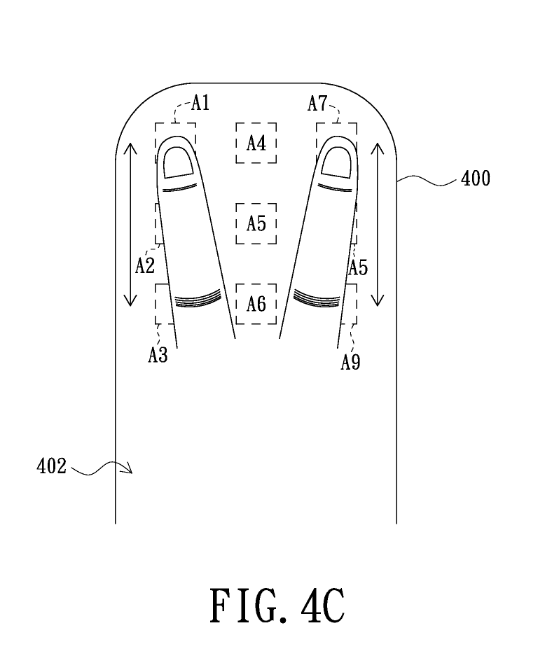

FIG. 4A to 4C are schematic views of operating the touch mouse in accordance with the exemplary embodiments of the present invention. Refer to FIGS. 3 and 4A, the exemplary embodiment employs a touch mouse 400 to describe the present invention. An upper shell 402 of the touch mouse 400 has a plurality of operation areas A1˜A9, and the touch mouse 400 comprises the control circuit 300 as shown in FIG. 3. When the user employ a finger to touch the upper shall 402 of the touch mouse 400 and move from up to down on the operation areas in a same column, such as the finger thereof touches the operation areas A4, A5 and A6 in sequence, the corresponding sensors A4, A5 and A6 are enabled at the moment and respectively output a detection signal DS[4:6] with the second status to the processing module 304.

When the processing module 304 receives the detection signal DS[4:6] with the second status, the decoder 312 decodes it and generates a decoding data D_DATA to the core unit 314. Therefore, the core unit 304 can generate an operation instruction OP_INS according to the amount and the sequence of the touched operation areas, and transmit the operation instruction OP_INS to the host device 320 through the transmission unit 308. In the exemplary embodiment, the host device 320 may be a computer system, and has a display to display image. Therefore, when the host device 320 receives the operation instruction OP_INS from the transmission unit 308, it can scroll up the image displayed by the display according to the operation instruction OP_INS. On the contrary, when the finger of the user touches the operation areas in the same column from down to up, the host device 320 can scroll down the image displayed by the display.

Referring to FIGS. 3 and 4B, if the user employ the finger to move from left to right on the operation areas in a same row, such as the finger thereof touches the operation areas A3, A6 and A9 in sequence, the corresponding sensors S3, S6 and S9 are respectively enabled at the moment. Similarly, the core unit 314 will generate the corresponding operation instruction OP_INS, and transmit it to the host device 320 through the transmission unit 308. At the moment, the host device 320 will scroll the image displayed by the display to the left. On the contrary, when the finger of the user moves from right to left on the operation areas in the same row, the host device 320 will scroll the image displayed by the display to the right.

The present invention also can have some specific applications. Referring to FIGS. 3 and 4C, when the user employ two fingers, such as the forefinger and the middle-finger, to moves from up to down on the operation areas in two column at the moment, such as the finger thereof touches the operation areas A1, A2, A3, and the operation areas A7, A8, A9 in sequence, the corresponding sensors S1, S2, S3 and the corresponding sensors S7, S8, S9 are enabled at the moment. Similarly, the core unit 314 will generate the corresponding operation instruction OP_INS, and transmit it to the host device 320 through the transmission unit 308, it will turn down the volume of the host device 320. On the contrary, when the user employ two fingers to move from down to up on the operation areas in two column, it will turn up the volume of the host device 320.

Of course, the touch mouse 400 described in the above exemplary embodiment may further has some operations which can perform the operations of the conventional mouse. For example, when the user move the touch mouse 400 and a pointer of the image displayed by the display of the host device points to one object of the image, the user can rap at least one of the operation areas A1, A2 and A3 to select the object pointed by the pointer. In addition, the user can rap at least one of the operation areas A1, A2 and A3 twice to turn on the object pointed by the pointer. Similarly, the user also can rap at least one of the operation areas A7, A8 and A9 to turn on a shortcut menu on the image.

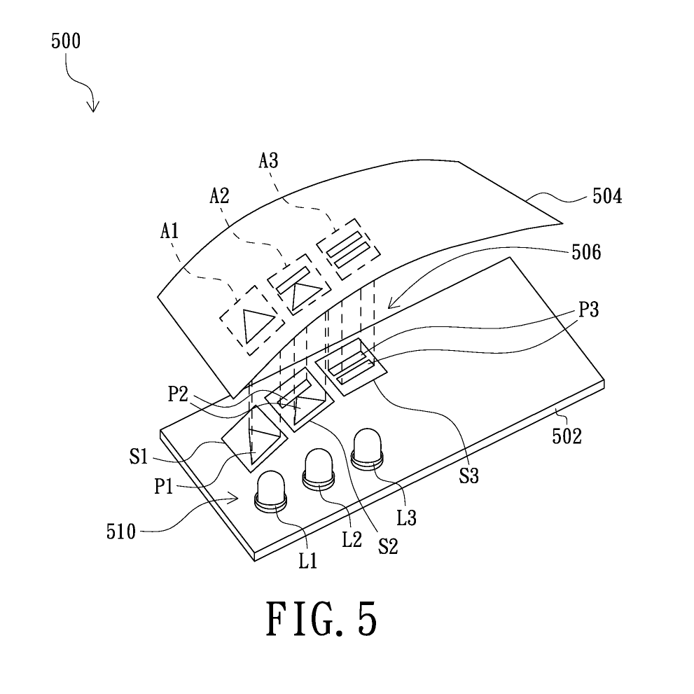

FIG. 5 is an exploded schematic view of an input device in accordance with other exemplary embodiment of the present invention. Referring to FIG. 5, the input device 500 of the exemplary embodiment also comprises a base 502, an upper shell 504 and a sensor array 506. The upper shell 504 covers the base 502, and the sensor array 506 comprises a plurality of sensors which are arranged at array under the upper shell 504. However, each of the sensors of the sensor array 506 respectively has a corresponding pattern. In addition, the pattern of each of the sensors, such as P1, P2 and P3, is made of a transparent material.

In addition, the input device 500 of the exemplary embodiment further comprises a light-source module 510 disposed between the sensor array 506 and the base 502. When the light-source module 510 is driven to emit light, the pattern of each of the sensors is respectively projected to one of the operation areas. In some exemplary embodiments, the light-source module 510 comprises a plurality of light-emitting diodes, such as L1, L2 and L3, and each of the light-emitting diodes L1, L2 and L3 respectively correspond to one of the sensors S1, S2 and S3.

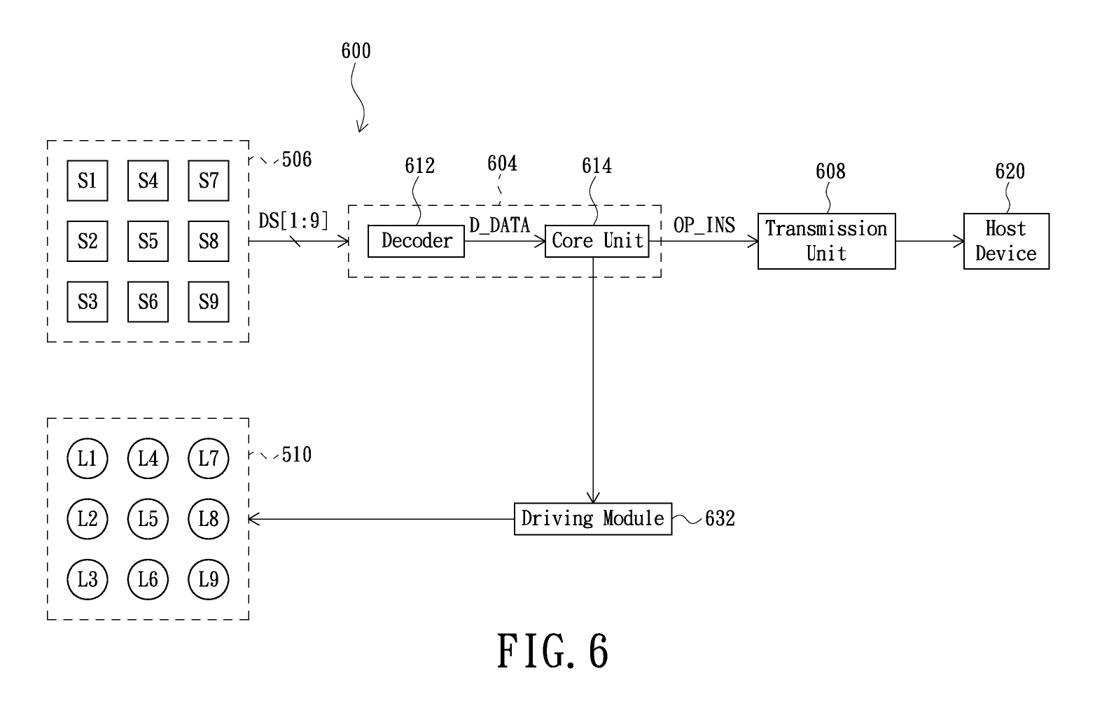

FIG. 6 is a circuit block view of a control circuit of an input device 500 in accordance with another exemplary embodiment of the present invention. Referring to FIGS. 5 and 6, the control circuit 600 of the exemplary embodiment comprises a sensor array 506, a processing module 604 and a transmission unit 608. The sensor array 506 is coupled to the processing module 604, and processing module 604 is linked with the host device 620 through the transmission unit 608. In the exemplary embodiment, the host device 620 may be home electronic device, presenter or projector. In addition, the processing module 604 comprises a decoder 612 and a core unit 614. The core unit 614 may be coupled to the transmission unit 608, and coupled to the sensor array 506 through the decoder 612.

The processing module 604 and the transmission unit 608 of the exemplary embodiment are similar with the processing module 304 and the transmission unit 308 of FIG. 3, thus they are not described in following. However, it should be noted that the control circuit 500 further comprises a driving module 632 coupled to the core unit 614 and the light-source module 510. The light-source module 510 comprises a plurality of light-emitting diodes L1˜L9. When the input device 500 is turned on, the core unit 614 can control the driving module 632 to output a driving current for driving the light-emitting diodes L1˜L9 to emit light.

The exemplary embodiment may be applied to achieve a touch remote controller configured for controlling some home electronic devices, such as speaker, audio-visual player, etc. Since the upper shell 504 of the input device 500 displays the projection of the pattern of each of the sensors S1˜S9, the user can select to touch one of the operation areas in the actual requirement of the uses. When the user touch one of the operation areas, a corresponding sensor is enabled, and a corresponding detection signal DS[n] is outputted to the processing module 604. Meanwhile the decoder 612 decodes the detection signal DS[n] and generates a decoding data D_DATA to the core unit 614. Therefore, the core unit 614 generates a corresponding operation instruction OP_INS according to the touched operation area to control the host device 620.

The exemplary embodiment employs an audio-video player as the host device 620 to describe the present invention. In addition, the operation area Al is defined as an operation of “play”. Therefore, when the user touch the operation area Al, the corresponding sensor S1 will output a detection signal S1 to the processing module 604. At the moment, the decoder 612 decodes the detection signal S1, and generates a decoding data D_DATA to the core unit 614. Thereafter, the core unit 614 generates an operation instruction OP_INS corresponding to the operation of “play”. The operation instruction OP_INS is transmitted to the host device 620 through the wireless transmission interface of the transmission unit 608, thus the host device 620 is controlled to perform the operation of “play”.

Particularly, in some exemplary embodiments, the above input device also can be implemented into a touch presenter, which has a principle same to that of the above description and is not limited in following.

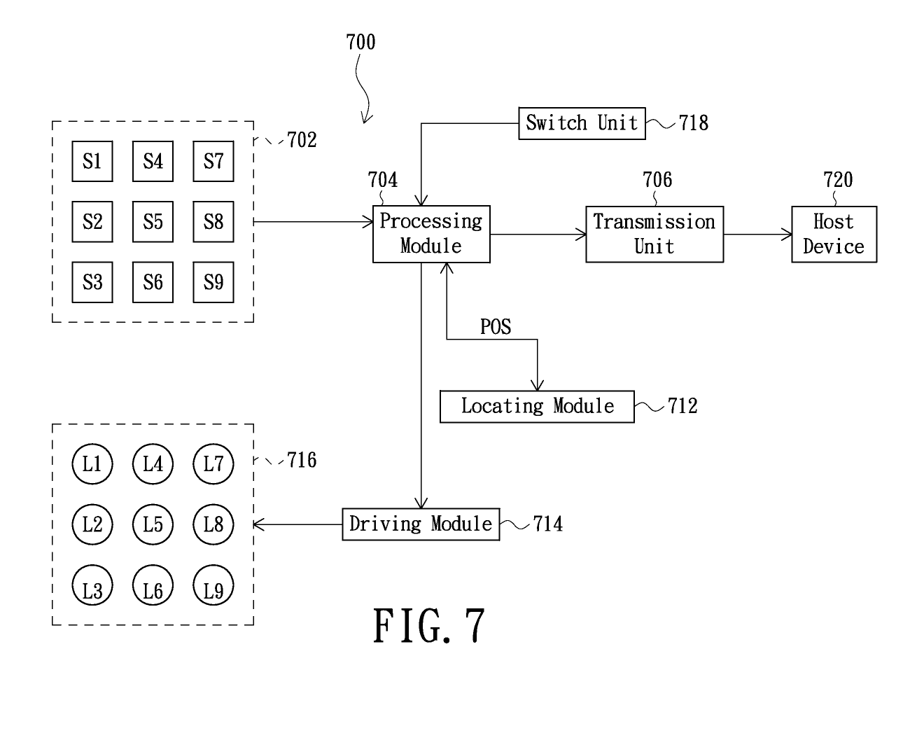

FIG. 7 is a circuit block view of a control circuit of a touch mouse with remote controlling function in accordance with a preferable exemplary embodiment of the present invention. Referring to FIG. 7, the control circuit of the touch mouse of the exemplary embodiment combines the control circuits 300 and 600 in actual needs to control the host device 720. In the exemplary embodiment, the control circuit 700 comprises a sensor array 702, a processing module 704, a transmission unit 706, a positioning module 712, a driving module 714 and a light-source module 716. The above components are introduced in detail in the above description, and the persons skilled in the art can refer to the above description.

It should be noted that the control circuit further comprises a switch unit 718 coupled to the processing module 704. The switch unit 718 is configured for switching operation modes of the control circuit 700. In detail, when the user needs to perform the operation by a mouse mode, the processing module 704 can enable the positioning module 712 and receive the positioning signal POS outputted therefrom. At the moment, the driving module 714 is disabled so as to save the power consumption. On the contrary, if the user employs the switch unit 718 to select a remote controller mode to perform the relative operations, the processing module 704 disables the positioning module 712, and enables the driving module 714 to output the driving current, for driving the light-emitting diodes L1˜L9 of the light-source module 716 to output the driving current. Thus, the pattern of each of the sensors S1˜S9 of the sensor array 702 is projected to the corresponding operation areas A1˜A9 respectively.

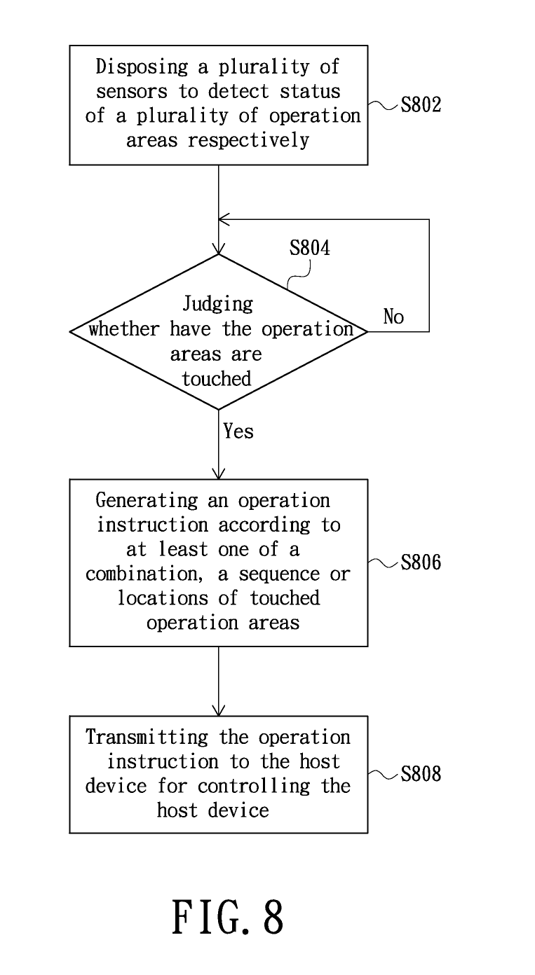

FIG. 8 is a flow chart of a control method of a host device in accordance with a preferable exemplary embodiment of the present invention. Referring to FIG. 8, firstly, a step S802 is disposing a plurality of sensors to respectively detect status of a plurality of operation areas. Then a step S804 is determining whether or not any of operation areas is touched. When at least one of the operation areas is touched, a step S806, which a corresponding operation instruction is generated according to a group, a sequence and locations of the touched operation areas, is performed. Then, a step 808 is performed to transmit the operation instruction generated in the step S806 to a host device through the wireless or wire transmission interface, to control the host device.

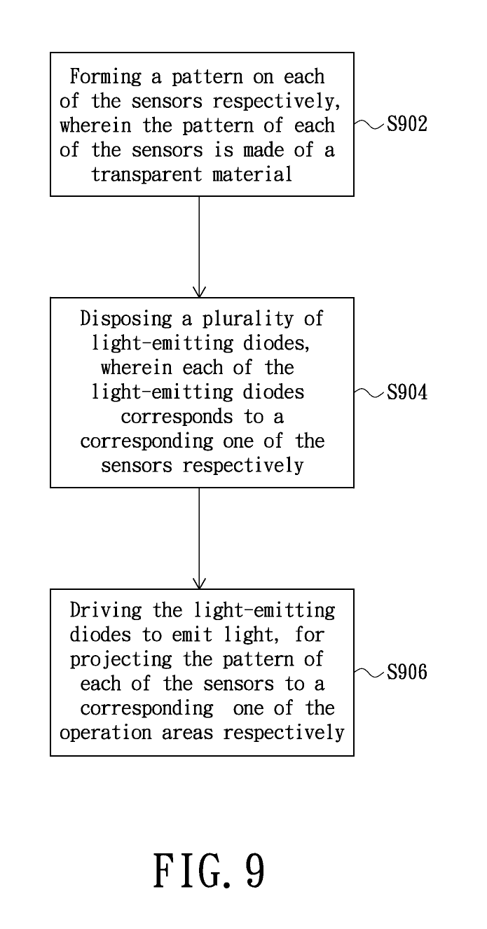

FIG. 9 is a flow chart of a control method of a host device in accordance with another exemplary embodiment of the present invention. Referring to FIG. 9, in some exemplary embodiments, a step S902 is forming a corresponding pattern on each of the sensors provided in the step S802, wherein the pattern of each of the sensors is made of a transparent material. Then, a step 904 is performed to dispose a plurality of light-emitting diodes, wherein each of the light-emitting diodes respectively corresponds to one of the sensors. Thereafter, a step 906 is performed to drive the light-emitting diodes to respectively project the pattern of each of the sensors to a corresponding one of the operation areas. Thus, the user can select the operations which should be performed, according to the pattern of each of the operation areas.

In summary, the present invention disposes the plurality of sensors arranged at array on the upper shell of the input device to sense the status of the operation areas of the upper shell. Therefore, the present invention can make the user conveniently read the files or the web-pages. In addition, since the present invention also project the patterns of the sensors to the upper shell, the user can conveniently remote control the operations of some home electronic devices.

In addition, the present invention disposes the plurality of sensors under the upper shell of the input device to sense the status of each of the operation areas, does not employ the touch panel to sense the operations of the user. Thus, the operation areas of the upper shell are not limited to be arranged at array, and they may be arranged according to the habit of the user or the actual needs.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An input device, comprising:
a base;
an upper shell covering the base and having a plurality of operation areas;
a sensor array disposed under the upper shell and having a plurality of sensors for detecting statuses of the operation areas respectively, wherein when any one of the operation areas is touched, a sensor corresponding to a touched operation area is enabled; and
a processing module coupled to the sensor array to generate a corresponding operation instruction according to a combination, a sequence and locations of enabled sensors when some of the sensors are enabled.

2. The input device as claimed in claim 1, wherein each of the sensors has a corresponding pattern respectively, and the pattern of each of the sensors is made of a transparent material.

3. The input device as claimed in claim 2, further comprising:
a light-source module disposed between the sensor array and the base to emit light, for projecting the pattern of each of the sensors to the corresponding operation areas respectively; and
a driving module coupled to the processing module and the light-source module to drive the driving module for emitting the light.

4. The input device as claimed in claim 3, wherein the light-source module comprises a plurality of light-emitting diodes, and each of the light-emitting diodes corresponds to one of the sensors respectively.

5. The input device as claimed in claim 1, wherein the operation areas are arranged at array.

6. The input device as claimed in claim 1, wherein the operation areas are arranged at non-array.

7. The input device as claimed in claim 1, further comprising a positioning module coupled to the processing module for detecting a location of a flat surface of the input device when the input device is used as a mouse, and generating a positioning signal to the processing module for generating the operation instruction.

8. The input device as claimed in claim 7, wherein the positioning module is one of a trackball positioning module and an optical positioning module.

9. The input device as claimed in claim 7, wherein the processing module comprises:
a decoder coupled to the sensor array and the positioning module for detecting the detection signal and the positioning signal; and
a core unit coupled to the decoder for generating the operation instruction according to a decoding result.

10. The input device as claimed in claim 1, further comprising a transmission unit coupled to the processing module and connected to a host device, for transmitting the operation instruction to the host device to control the host device.

11. The input device as claimed in claim 10, wherein the transmission unit is connected to the host device through a universal serial bus transmission interface.

12. The input device as claimed in claim 10, wherein the transmission unit is connected to the host device through a wireless transmission interface.

13. A control circuit adapted for controlling a host device, comprising:
a sensor array having a plurality of sensors arranged under a plurality of operation areas at array, each of the sensors detecting a status of a corresponding one of the operation areas respectively, and when any one of the operation areas is touched, a sensor corresponding to a touched operation area is enabled; and
a processing module coupled to the sensor array, to generate a corresponding operation instruction according to a combination, a sequence and locations of enable sensors when some of the sensors are enabled, such as to control the host device.

14. The circuit control as claimed in claim 13, further comprising a transmission unit coupled to the processing module and linked with the host device, for transmitting the operation instruction to the host device.

15. The control circuit as claimed in claim 13, wherein each of the sensors has a corresponding pattern respectively, and the pattern of each of the sensors is made of a transparent material.

16. The control circuit as claimed in claim 15, further comprising:
a light-source module disposed under the sensor array to emit light, for projecting the pattern of each of the sensors to the corresponding operation areas respectively; and
a driving module coupled to the processing module and the light-source module, to drive the driving module for emitting the light.

17. The control circuit as claimed in claim 16, wherein the light-source module comprises a plurality of light-emitting diodes, and each of the light-emitting diodes corresponding to one of the sensors respectively.

18. The control circuit as claimed in claim 13, wherein the processing module comprises:
a decoder coupled to the sensor array and the positioning module, for detecting the detection signal and the positioning signal; and
a core unit coupled to the decoder for generating the operation instruction according to a decoding result.

19. An electronic system, comprising:
a host device; and
an input device linked with the host device for controlling the host device, and the input device comprising:
an upper shell having a plurality of operation areas;
a sensor array disposed under the upper shell and having a plurality of sensors for detecting statuses of the operation areas respectively, wherein when any one of the operation areas is touched, a sensor corresponding to a touched operation area is enabled; and
a processing module coupled to the sensor array to generate a corresponding operation instruction according to a combination, a sequence and locations of enabled sensors when some of the sensors are enabled.

20. The electronic system as claimed in claim 19, wherein each of the sensors has a corresponding pattern respectively, and the pattern of each of the sensors is made of a transparent material.

21. The electronic system as claimed in claim 20, wherein the input device further comprises a plurality of light-emitting diodes, and each of the light-emitting diodes corresponds to one of the sensors respectively to emit light for projecting the pattern of each of the sensors to a corresponding one of the operation areas.

22. A control method for a host device, comprising:
disposing a plurality of sensors at array, to detect statuses of a plurality of operation areas respectively;
generating an operation instruction according to a combination, a sequence and locations of touched operation areas when some of the operation areas are touched; and
transmitting the operation instruction to the host device for controlling the host device.

23. The control method as claimed in claim 22, further comprising:
forming a corresponding pattern on each of the sensors, and the pattern of each of the sensors is made of a transparent material;
disposing a plurality of light-emitting diodes, and each of the light-emitting diodes respectively corresponds to one of the sensors respectively; and
driving the light-emitting diodes to emit light, for projecting the pattern of each of the sensors to a corresponding one of the operation areas.
